(19) United States
(12) Patent Application Publication
(10) Pub. No.: US 2008/0262466 A1
(43) Pub. Date: Oct. 23, 2008

(54) STORAGE CONTAINER

(76) Inventors: Steve Smith, Irvine, CA (US); Joachim Beine, Guxhagen (DE)

Correspondence Address: KLEIN, O'NEILL & SINGH, LLP, 43 CORPORATE PARK, SUITE 204, IRVINE, CA, 92606, US

(21) Appl. No.: 12/105,055

(22) Filed: Apr. 17, 2008

Related U.S. Application Data
(60) Provisional application No. 60/912,881, filed on Apr. 19, 2007.

(51) Int. Cl. A61J 1/00

(52) U.S. Cl. 604/415; 215/247; 215/392

(57) ABSTRACT

Storage containers for storing fluids are generally discussed herein with particular discussions on storage containers having a rubber septum for port access. Aspects of the present invention further include provisions for a gasket to displace an internal space between a cap and a nozzle of a storage container to minimize or eliminate seepage into the same space.

### CROSS-REFERENCE TO RELATED APPLICATION

This application claims the benefit of U.S. Provisional Application No. 60/912,881, filed Apr. 19, 2007, the disclosure of which is incorporated herein by reference.

### BACKGROUND

Storage containers for storing fluids are generally discussed herein with particular discussions on storage containers having a rubber septum for port access.

Containers for dispensing fluids come in many shapes, types and sizes. A typical container includes a vial or a container body, a cap, and a seal for sealing the interface therebetween. The cap may be removable for dispensing the stored fluid or a separate channel, port, or weakened section provided for dispensing the stored fluid.

For a nutritional or therapeutic container designed for intravenous use, the container further includes means for port access. This typically involves use of a rubber septum to be punctured by a spike. However, while a rubber septum is able to seal around a spike, the interface between the septum and the vial or between the cap and the vial provides crevices for the fluid to seep into, which gives the appearance of leakage.

Accordingly, there is a need for a port access type container that is easy to make, fill, and seal and that, among other things, minimizes or eliminates leakage into the crevices between the cap and the vial.

### SUMMARY

The present invention may be implemented by providing a storage container comprising a vial comprising a nozzle comprising a shoulder; a cap positioned over the nozzle comprising a skirt defining an interior cavity having a stopper positioned therein; wherein the nozzle is sealed by an upper nozzle dome layer; and wherein a pliable gasket is positioned between and in contact with at least one of the upper nozzle dome layer and the stopper.

Other aspects of the present invention include a storage container comprising a vial comprising a nozzle comprising a shoulder; a cap positioned over the nozzle comprising a skirt defining an interior cavity having a stopper positioned therein and a flange; wherein the nozzle is sealed by an upper nozzle dome layer and the shoulder and the flange bonded to one another; and wherein a pliable gasket is positioned between the upper nozzle dome layer and the stopper.

In yet another aspect of the present invention, there is provided a method of using a gasket with a storage container to displace available space comprising: forming a container body from hot parison by forming a closed end; the container body defining a volumetric storage space; filling the storage space with a fluid; forming a nozzle comprising an open end and a shoulder and sealing the open end; providing a cap with a stopper disposed therein; placing the cap over the nozzle of the sealed open end; and providing a gasket in between the stopper and the sealed open end to displace at least some of the available space.

The containers as provided above may be made from a blow-fill-seal process.

In yet other aspects of the present invention, a shoulder on the container nozzle and a flange on the cap may be attached to one another by injection attachment.

In accordance with still other aspects of the present invention, the gasket may be stamped and placed into the cap as a sub-assembly or injected in place with the cap over the nozzle.

In one particular preferred embodiment, a method for reducing fluid flow space between a cap and a nozzle of a container is provided which includes the steps of placing a stopper in the cap; and placing a foam material between the stopper and the nozzle to displace the fluid flow space with the foam material.

In still yet another aspect of the present invention, there is provided a method of using a gasket with a storage container to displace available space comprising forming a container body from hot parison by forming a closed end; the container body defining a volumetric storage space; filling the storage space with a fluid; forming a nozzle comprising an open end and a shoulder and sealing the open end by pinching the nozzle; providing a cap with a stopper disposed therein; placing the cap over the nozzle of the sealed open end; and providing a gasket in between the stopper and the sealed open end to displace at least some of the available space.

Other aspects and features of the storage containers provided herein may be better appreciated as the same become better understood with reference to the specification, claims, and appended drawings.

### BRIEF DESCRIPTION OF THE DRAWINGS

The appended drawings include:

FIG. 1, which is an exploded perspective view of a storage container provided in accordance with aspects of the present invention;

FIG. 2, which is a partial cross-sectional view of the storage container of FIG. 1 in an assembled state;

FIG. 3, which is a partial cross-sectional partial perspective view of the storage container of FIG. 2, which shows a cut-out on a gasket in relations to two indentations on a stopper;

FIG. 4, which is a partial cross-sectional view of an alternative storage container provided in accordance with other aspects of the present invention;

FIG. 5, which is a partial cross-sectional side view of a mold for attaching the shoulder and the flange of the cap and container using injection attachment;

FIG. 6, which is a partial cross-sectional side view of multi-laminate peelable cover provided in accordance with aspects of the present invention; and

FIG. 7, which is a cross-sectional side view of a polymeric peelable layer.

### DETAILED DESCRIPTION

The detailed description set forth below in connection with the appended drawings is intended as a description of the presently preferred embodiments of storage containers provided in accordance with aspects of the present invention and is not intended to represent the only forms in which the present invention may be constructed or utilized. The description sets forth the features and the steps for constructing and using the storage containers of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

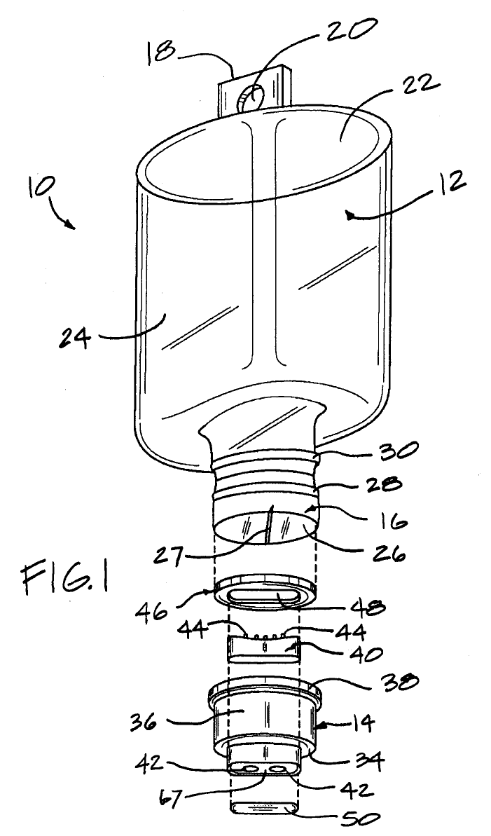

Referring now to FIG. 1, an exploded perspective view of a storage container provided in accordance with aspects of the present invention is shown, which is generally designated 10. In one exemplary embodiment, the storage container 10 includes a container body 12 defining a volumetric storage space and a cap 14 for capping a nozzle 16. For simplicity, the container body 12 may be referred to herein as a vial, which represents the container body shown and more generally any volumetric storage space.

In one exemplary embodiment, the vial 12 includes a hanger 18 having an opening 20 on a base 22, opposite the end with the nozzle 16. The vial 12 is preferably formed form a blow-fill-seal process, which is well known in the art. More particularly, the body section 24, the base 22, and the hanger 18 are first formed from hot parison. The formed body section 24 is then filled with a fluid and then the nozzle 16 is formed, which includes a dome 26 for sealing in the fluid, such as IV fluid therapy, drug delivery, parenteral nutrition, or other desired fluids. The dome 26 may be formed by pinching the hot parison during the nozzle formation process, which typically leaves a pinch line 27. The vial may be made from a number of thermoplastic materials with low density polyethylene (LDPE), high density polyethylene (HDPE), and polypropylene material being more preferred and with LDPE being most preferred. Although vent ports may be incorporated, the vial 12 is pliable and collapsible to allow fluids to drain therefrom without them.

In one exemplary embodiment, the nozzle 16 has a cylindrical tubular shape and incorporates a lip or bead 28 and a flange or shoulder 30 for mating with the cap 14, as further discussed below. However, the nozzle 16, and also the body section 24, may be completed with different geometries, which include different sizes, different cross-sectional shapes, different lengths, different spacing between the bead 28 and the shoulder 30, etc., without deviating from the spirit and scope of the present invention.

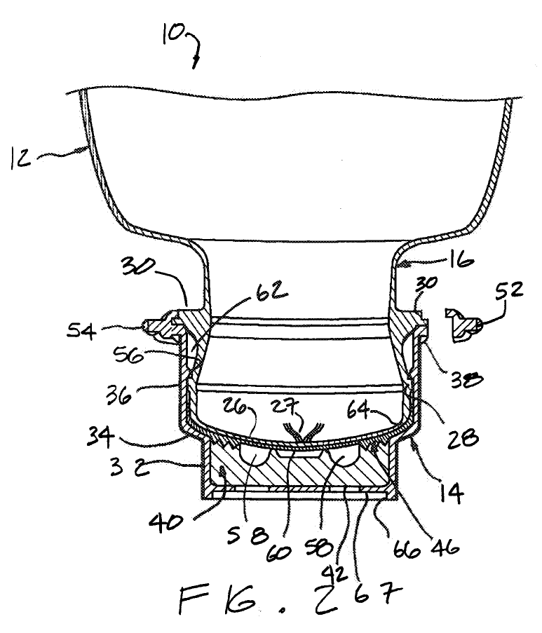

In one exemplary embodiment, the cap 14 incorporates a receiving section 32 (FIG. 2) projecting from a cap surface 34, a skirt section 36, and a flange 38, which is configured to mate with the flange 30 on the nozzle 16. Internally, a bead (56, FIG. 2) is incorporated to engage with the bead 28 on the nozzle 16 for retaining the cap to the nozzle during assembly, as further discussed below.

The receiving section 32 is preferably integrally formed to the skirt section 36 and projects a sufficient amount from the cap surface 34 to accommodate a stopper 40. Although the receiving section 32 is shown with an oblong shape, it may incorporate any number of geometries, including circular, square, rectangular, polygon, etc. In one exemplary embodiment, the receiving section 32 is incorporated with two access holes or through holes 42, although one or more than two may be incorporated. The access holes 42 permit a spike and a needle to be inserted through the receiving section without first piercing through the cap material. The cap 14 may be made from standard prior art molding techniques, such as injection molding, using a HDPE material.

The stopper 40 provided in accordance with aspects of the present invention may be made from a thermoplastic elastomer material, such as KRATON®, ethylene-propylene diene monomer (EPDM), polyisoprene, SANOPRENE™, and PEBAX™. In a preferred embodiment, the stopper 40 is molded directly into the receiving section 32 of the cap. However, the stopper may also be made separately from a thermal set material and subsequently added to the cap 14. A plurality of projections 44 may be formed to an underside of the stopper 40 to minimize surface to surface contact between the dome 26 on the nozzle 16 and the stopper 40.

In one exemplary embodiment, a gasket 46 is incorporated. The gasket 46 may be stamped from a foam, low density or HDPE, sheet and includes a cut-out 48 sized so that the perimeter of the cut-out is outside of the path of insertion of a spike. In other words, the cut-out is preferably sized so that no part of the gasket is pierced by a spike or a medication additive needle. This avoids the possibly of transferring foam fragments to the dispensed fluid. The thickness of the gasket 46 may be sufficiently thick to fill the gap or space located between the dome 26 on the nozzle 16 and the cap surface 34, as further discussed below.

A peelable cover 50 for providing sterility may be sealed to the receiving section 32. The cover 50 may be peelable from the receiving section prior to use and preferably includes a pull tab (not shown) to facilitate gripping. As further discussed below, the peelable cover 50 may be bonded to the receiving section and may include a polymeric material or a multi-laminate layer that includes an aluminum foil layer.

FIG. 2 is a partial cross-sectional side view of the storage container 10 of FIG. 1, which shows the flange 38 on the cap 14 placed against the flange 30 on the nozzle 16 of the vial 12. In practice, a mold is used to clamp the two flanges 30, 38 and molten polymeric material injected to form a ring 52 for bonding the two flanges together in a process known as injection attachment. The resultant ring is shown as a welded flange 54 in FIG. 2. In one exemplary embodiment, molten polypropylene (PP) material is used to fuse the two flanges 30, 38 together. However, HDPE, LDPE, or other polymeric material may also be used. While the welded flange 54 is shown with stepped surfaces, any configurations, contours, and shapes may be used without deviating from the spirit and scope of the present invention.

As previously discussed, a lip or bead 56 is incorporated internally of the cap 14 to engage with the lip or bead 28 on the nozzle 16. This engagement allows the cap 14 to be temporarily secured to the nozzle 16 during the ring formation.

In one exemplary embodiment, the stopper 40 includes one or more craters or indentations 58, 60. The two indentations 58 subjacent the two access holes 42 on the cap are optional and when incorporated, are configured to minimize the thickness of the stopper 40 at the puncture site for a spike or needle to facilitate puncturing. The middle indentation 60 is also optional and when incorporated is configured to minimize direct surface-to-surface contact between the stopper 40 and the dome 26. In one exemplary embodiment, the number of indentations 58, 60 formed in the stopper corresponds with the number of openings 42 formed on the receiving section 32 of the cap 14 (FIG. 1). The indentations 58, 60 may have a variety of shapes and depths without deviating from the spirit and scope of the present invention.

As previously indicated, when a spike (not shown) punctures through the stopper 40 and through the dome 26 of the vial 12, the spike is sealed along its external surface by the stopper, which prevents leakage around the external periphery of the spike. However, as the space 62 between the stopper 40 and the dome surface 26 of the vial 12 is not sealed, dispensed fluid may leak into and fill the space 62 near the skirt 36. Thus, in accordance with one aspect of the present invention, a foam gasket 46 is provided between the stopper 40 and the dome 26 on the vial 12. The gasket 46, which in one embodiment is formed by stamping a foam sheet, may be placed into the skirt section 36 of the cap 14 as a sub-assembly. The sub-assembly may then be placed over the nozzle 16 and the two flanges 30, 38 clamped and welded, as previously discussed. In one exemplary embodiment, the foam sheet may be a LDPE foam sheet. However, other pliable foam sheet material may be used without deviating from the spirit and scope of the present invention.

In one exemplary embodiment, the gasket 46 is sized so that its periphery extends into the skirt section 36 of the cap and pinched between the cap surface 34 and the outer ridges 64 of the nozzle 16 and the dome 26. During autoclave sterilization and the container's temperature is raised, the polyethylene gasket 46 approaches its softening point and may thermally bond to the dome 26 on the vial 12 and the stopper 40. Whether the gasket 46 forms a bond with the vial and the stopper or not, the presence of the gasket acts to displace the space 62 between the cap and the nozzle to reduce or eliminate liquid flowing into the same space.

In one exemplary embodiment, a lip 66 is incorporated at the top surface 67 of the receiving section 32. The lip 66 and the top surface 67 form a recess for receiving a peelable cover 50 (not shown). However, the peelable cover 50 may be bonded directly to the top surface 67 without the lip 66.

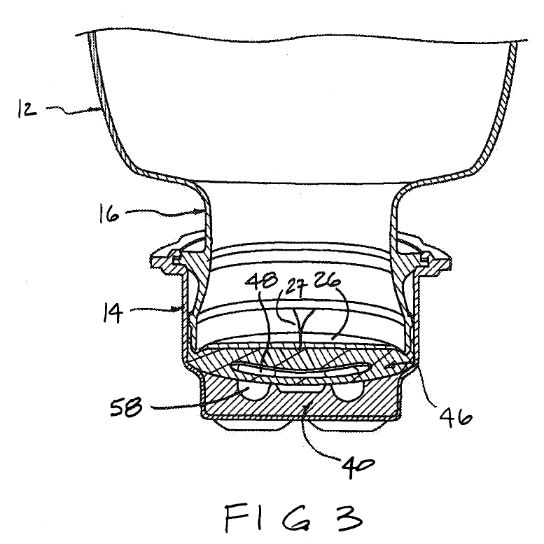

FIG. 3 is a partial cross-sectional partial perspective view of the container 10 of FIG. 2. The relative position of the cut-out 48 on the gasket 46 and the two craters 58 located on the stopper 40 is shown. As is readily apparent to a person of ordinary skill in the art, the cut-out 48, shown having an oblong shape, may incorporate a different shape, such as circular or rectangular, provided the perimeter of the cut-out is outside of a path to be taken by a spike when the same is used to puncture the stopper 40.

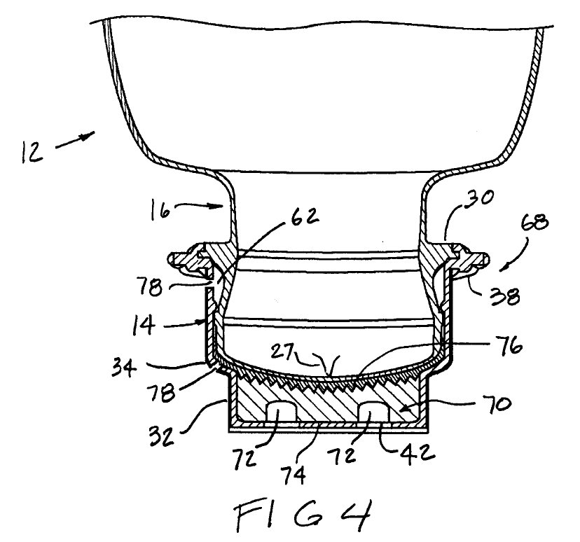

Referring now to FIG. 4, a cross-sectional side view of an alternative container 68 provided in accordance with aspects of the present invention is shown. In the present embodiment, a stopper 70 having two concave craters 72 formed along its upper surface 74 and a plurality of bumps on its lower surface 76 is used. The stopper 70 may be formed in place with the two craters 72 created by inserting two core pins (not shown) through the two openings 42 of the receiving section 32 or as a thermal set that is placed into the cap as a sub-assembly.

In one exemplary embodiment, two or more injection passages 78 are formed along the cap surface 34 and/or the skirt section 36 of the cap 14, near the flange 38. The injection passages 78 may be used as means for injecting polyethylene foam into the space 62 between the stopper 70 and the nozzle 16. In practice, during the injection attachment process for forming a ring around the two flanges 38, 30, liquefied polyethylene foam is injected into the space 62 inside the cap 14 through the two or more injection passages 78. Once the foam is cooled, it solidifies and displaces the space or gap between the top surface 34 of the cap and the dome 26 on the vial 12. In another embodiment, both a stamped foam sheet and liquefied foam injection may be used to displace the gap or space between the cap and the dome and nozzle section of the vial.

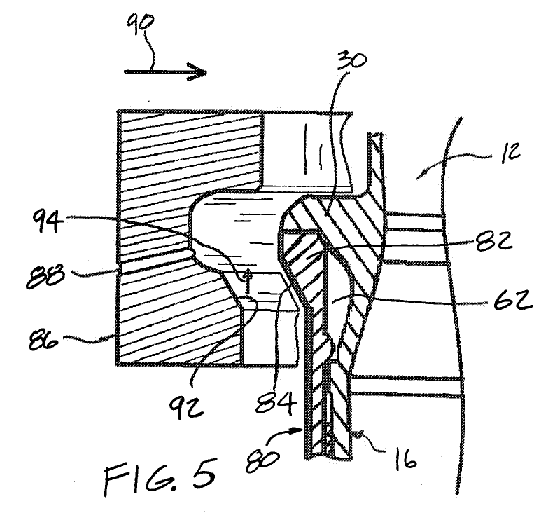

FIG. 5 is a partial cross-sectional side view of an alternative cap 80 positioned over a vial 12 and the flange 30 on the vial abutting the flange 82 on the cap 80. In one exemplary embodiment, the flange 82 on the cap incorporates a tapered shoulder 84 having a first slope. As previously discussed, the two flanges 30, 82 may be welded together using a process known as injection attachment, which involves clamping two mold halves 86 (only one shown) around the nozzle 16 and cap 80 and injecting liquefied polymeric material through one or more injection ports 88 (only one shown) to fuse the two flanges together. The resultant flange resembles the flange 54 shown in FIG. 2, with a different outer contour due to a different mold design.

When two mold halves 86 are clamped around the nozzle 16 and cap 80, they move in an orthogonal direction 90 to the longitudinal axis of the vial 12. Thus, while the two flanges 30, 38 are held together, they may not be axially compressed together as desired. To generate a compressive force on the two flanges 30, 82, a tapered shoulder 92 having a second slope is incorporated in the mold cavity. The second slope may have a value greater than or less than the first slope 84 on the cap. When the two dissimilar slopes meet, they produce a pair of component forces having an equivalent axial force component 94 in the direction of the longitudinal axis of the vial 12. Thus, where a stamped gasket is used to displace at least some of the space between the cap 80 and the nozzle 16, such as the gasket 46 in FIG. 1, the axial force 94 is configured to compress the gasket to provide a seal between the cap surface and the nozzle to limit or eliminate leakage into the internal space section 62 of the cap.

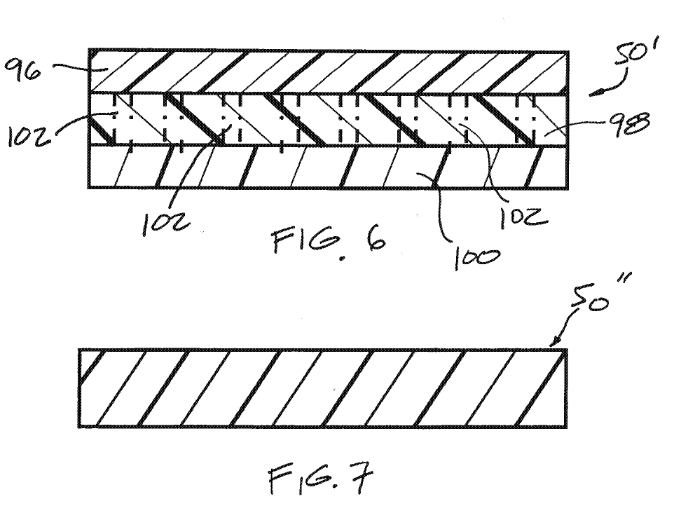

Turning now to FIG. 6, a partial cross-sectional view of a peelable cover 50′ for covering the upper surface 67 of the nozzle 16 of FIG. 1 is shown. In one exemplary embodiment, the peelable cover 50′ comprises a multi-layer laminate sheet, which includes a lower polymeric layer 96, which is preferably a polyethylene-polybutylene blend, a middle moisture impermeable foil layer 98, and an outer polymer layer 100, which is preferably Polyethylene Terephthalate (PET). The three layers 96, 98, 100 may be bonded to one another using known prior art bonding techniques. The lower layer 96 is configured to be attached to the cap.

In one exemplary embodiment, the peelable cover 50′ is heat sealed to the upper surface 67 of the cap with the lower layer 96 directly facing the upper surface 67 of the cap. Because the foil layer 98 is moisture impermeable, no moisture can permeate through to the cap 14 during autoclave sterilization, which is not preferred and possibly not acceptable for autoclave sterilization. Thus, in accordance with one aspect of the present invention, pluralities of perforated holes 102, and more preferably a plurality of micro-performed holes, are formed in the foil layer 98 for moisture permeability. In one exemplary embodiment, at least some of the micro-perforated holes are formed in a pattern directly over the two access holes 42 (FIG. 1) on the cap to ensure moisture penetration through the cap. The micro-perforated holes are preferably sized sufficiently large and in quantity to ensure adequate moisture flow to satisfy autoclave sterilization but not so large in size or number so as to compromise the structural integrity of the aluminum foil layer and be susceptible to tearing. The micro-perforated holes 102 may be formed in a pattern or at random and the foil layer should be sufficiently thick so that as the peelable cover 50′ is bent back to expose the access holes 42 on the cap (FIG. 1), the foil layer maintains the peelable layer in a folded-back state.

FIG. 7 is a cross-sectional side view of an alternative peelable cover 50″ provided in accordance with aspects of the present invention. In the alternative peelable cover 50″, a single polymeric layer, such as a PET material, is used to heat seal to the upper surface 67 of the cap. The cover 50″ is moisture permeable and may be attached directly to the upper surface 67 of the cap. Both peelable covers 50′ and 50″ of FIGS. 6 and 7 preferably include a pull tab to facilitate pulling and removing the cover from the container (not shown).

In a further aspect of the present invention, a method is provided for displacing space between the cap 14 and the nozzle 16. In one method, a foam material is used to displace the space. In another method, a foam material is used in combination with a compressive force to displace the space. In another method, liquefied foam material is used to inject into the space to displace the same with foam material. In yet another method, a combination of foam sheet material and liquefied foam material is used to displace the space with foam material.

In yet other aspects of the present invention, a method is provided for minimizing the presence of fluid in the space between the cap 14 and the nozzle 16. In a specific embodiment, foam is placed in the available space so that less space or zero space is available for displaced fluid to leak into said same space.

Although limited embodiments of the storage containers and their components have been specifically described and illustrated herein, many modifications and variations will be apparent to those skilled in the art. For example, the containers may be made transparent, semi-transparent, or opaque, the nozzle may include additional beads or ribs, the shape of the container may be different, and the materials used may be a composite. Accordingly, it is to be understood that the storage containers and their components constructed according to principles of this invention may be embodied other than as specifically described herein. The invention is also defined in the following claims.

What is claimed is:

1. A storage container comprising a vial comprising a nozzle comprising a shoulder; a cap positioned over the nozzle comprising a skirt defining an interior cavity having a stopper positioned therein; wherein the nozzle is sealed by an integrally formed upper nozzle dome layer; and wherein a pliable gasket is positioned between and in contact with at least one of the upper nozzle dome layer and the stopper.

2. The storage container of claim 1, wherein the vial comprises a base comprising a hanger.

3. The storage container of claim 1, wherein the cap comprises a shoulder in abutting contact with the shoulder on the nozzle.

4. The storage container of claim 3, wherein the two shoulders are attached to one another by solidified molten polymeric material.

5. The storage container of claim 3, wherein the pliable gasket is obtained from a foam sheet.

6. The storage container of claim 3, wherein the cap comprises a plurality of nozzles sized to receive injectable foam material.

7. A method for reducing fluid flow space between a cap and a nozzle of a container comprising:
placing a stopper in the cap; and
placing a foam material between the stopper and the nozzle to displace the fluid flow space with the foam material.

8. The method of claim 7, wherein the foam material is injected through a wall surface of the cap.

9. The method of claim 7, wherein the nozzle has a closed upper surface and wherein the stopper has a plurality of projections positioned adjacent the closed upper surface.

10. The method of claim 7, wherein the foam material is obtained from a foam sheet material.

11. The method of claim 7, wherein the container is made from a blow-fill-seal process.

12. The method of claim 7, further comprising placing a peelable layer over an upper exterior surface of the cap.

13. The method of claim 12, wherein the peelable layer is a multi-layer laminate that includes a foil layer.

14. The method of claim 13, wherein the foil layer comprises a plurality of micro-perforated holes.

15. The method of claim 7, wherein the cap comprises an upper exterior surface and a hole penetrated therethrough.

16. A method of using a gasket with a storage container to displace available space comprising:
forming a container body from hot parison by forming a closed end; the container body defining a volumetric storage space;
filling the storage space with a fluid;
forming a nozzle comprising an open end and a shoulder and sealing the open end by pinching the nozzle;
providing a cap with a stopper disposed therein;
placing the cap over the nozzle of the sealed open end; and
providing a gasket in between the stopper and the sealed open end to displace at least some of the available space.

17. The method of claim 16, wherein the gasket is formed by injecting a foam material through one or more passages on the cap.

18. The method of claim 16, wherein a portion of the gasket is obtained from a foam sheet.

19. The method of claim 16, wherein the nozzle has an annular lip and the cap has an interior annular bead.

20. The method of claim 19, wherein the annular lip and the annular bead engage one another to retain the cap over the nozzle.

21. The method of claim 16, further comprising a peelable layer located on the cap.

22. The method of claim 21, wherein the peelable layer comprises a foil layer comprising a plurality of perforated holes.
